(19) United States
(12) Patent Application Publication
(10) Pub. No.: US 2014/0300563 A1
(43) Pub. Date: Oct. 9, 2014

(54) CONTROL DEVICE AND CONTROL METHOD

(71) Applicant: FUJITSU LIMITED, Kawasaki-shi (JP)

(72) Inventor: Yusuke IWAKI, Sapporo (JP)

(73) Assignee: FUJITSU LIMITED, Kawasaki-shi (JP)

(21) Appl. No.: 14/243,714

(22) Filed: Apr. 2, 2014

(30) Foreign Application Priority Data
Apr. 9, 2013 (JP) 2013-081656

(51) Int. Cl. G06F 3/041

(52) U.S. Cl. CPC G06F 3/041
USPC 345/173

(57) ABSTRACT

A control device includes a memory; and a processor coupled to the memory, configured to perform first detection in order to detect write operation by a user on a first display image displayed on a display device, when the write operation is detected by the first detection, associate first feature information calculated from the first display image with write data by the write operation, and store the first feature information and the write data into the memory, perform second detection in order to detect display of a second display image whose second feature information corresponding to the stored first feature information is calculated on the display device, and when the display of the second display image is detected by the second detection, display the write data stored in association with the first feature information together with the second display image on the display device.

### CROSS-REFERENCE TO RELATED APPLICATION

This application is based upon and claims the benefit of priority from the prior Japanese Patent Application No. 2013-081656 filed on Apr. 9, 2013, the entire contents of which are incorporated herein by reference.

### FIELD

The embodiments discussed herein are related to a control device and a control method.

### BACKGROUND

To date, applications that accept comments have included a comment input unit and a comment display unit, and the comments have been held in a specific format as meta-data of a file being displayed. For example, in Portable Document Format (PDF), which is used in electronic documents, meta-data of comments are held in a PDF document file. And when a user displays the PDF document file using specific software, the comments input in the past are read and displayed.

Also, a technique has been known in which a user adds a marking symbol to displayed data through a pen and a touch panel so that the user is allowed to search for data with the added marking symbol using the marking symbol as a search key. For example, such a technique has been disclosed in Japanese Laid-open Patent Publication No. 2007-265251. Also, a technique has been known in which a comment written from a handwriting tablet by a user is associated with document data, and then the comment data associated with the document is read from a file to be displayed. For example, such a technique has been disclosed in Japanese Laid-open Patent Publication No. 5-342209.

### SUMMARY

According to an aspect of the invention, a control device includes a memory; and a processor coupled to the memory, configured to perform first detection in order to detect write operation by a user on a first display image displayed on a display device, when the write operation is detected by the first detection, associate first feature information calculated from the first display image with write data by the write operation, and store the first feature information and the write data into the memory, perform second detection in order to detect display of a second display image whose second feature information corresponding to the stored first feature information is calculated on the display device, and when the display of the second display image is detected by the second detection, display the write data stored in association with the first feature information together with the second display image on the display device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a diagram illustrating an example of a control device according to a first embodiment;

FIG. 1B is a diagram illustrating an example of signal flows and control operation in the control device illustrated in FIG. 1A;

FIG. 2A is a diagram illustrating an example of an information processing apparatus according to a second embodiment;

FIG. 2B is a diagram illustrating an example of signal flows in the information processing apparatus illustrated in FIG. 2A;

FIG. 3A is a diagram illustrating an example of a hardware configuration of the information processing apparatus;

FIG. 3B is a diagram illustrating an example of a tablet terminal to which the information processing apparatus is applied;

FIG. 4 is a diagram illustrating an example of comment data storage;

FIG. 5 is a diagram illustrating an example of reading comment data;

FIG. 6 is a flowchart illustrating an example of storage processing of comment data;

FIG. 7 is a flowchart illustrating an example of read processing of comment data;

FIG. 8A is a diagram illustrating an example of comments input by a user;

FIG. 8B is a diagram illustrating an example of feature vectors;

FIG. 9A is a diagram illustrating an example of an ER diagram on data stored in a comment data storage unit;

FIG. 9B is a diagram illustrating an example of a comment table stored in the comment data storage unit;

FIG. 9C is a diagram illustrating an example of a feature vector table stored in the comment data storage unit;

FIG. 10A is a diagram (1 of 2) illustrating an example of database collation of past comments;

FIG. 10B is a diagram (2 of 2) illustrating an example of database collation of past comments;

FIG. 11A is a diagram illustrating an example of a display image at comment input time; and

FIG. 11B is a diagram illustrating an example of a comment display of another display image.

### DESCRIPTION OF EMBODIMENTS

In the related art described above, comment data is stored in association with information on an application, document data, and so on. Accordingly, there has been a problem in that whether a writing function is available or not depends on an application, a format of document data, and the like. It has been, therefore, difficult to achieve a flexible writing function.

In the following, a detailed description will be given of a control device, a control method, and a control program according to embodiments of the present disclosure with reference to the drawings.

### First Embodiment

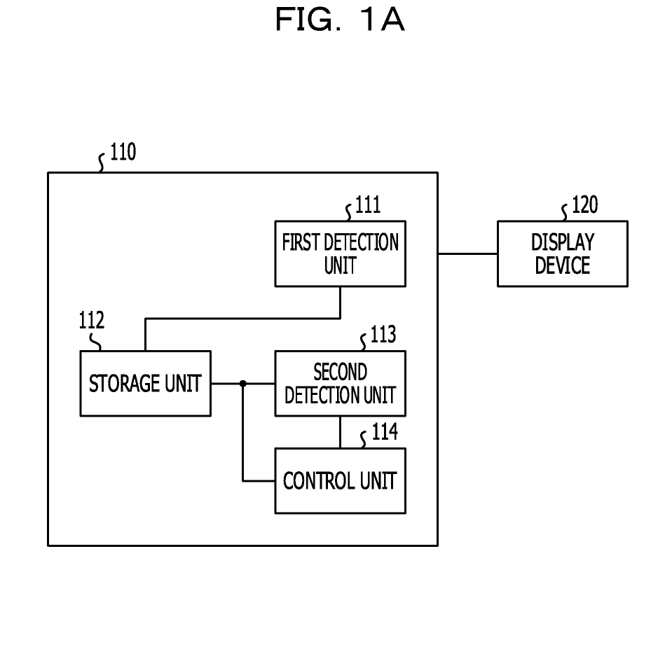

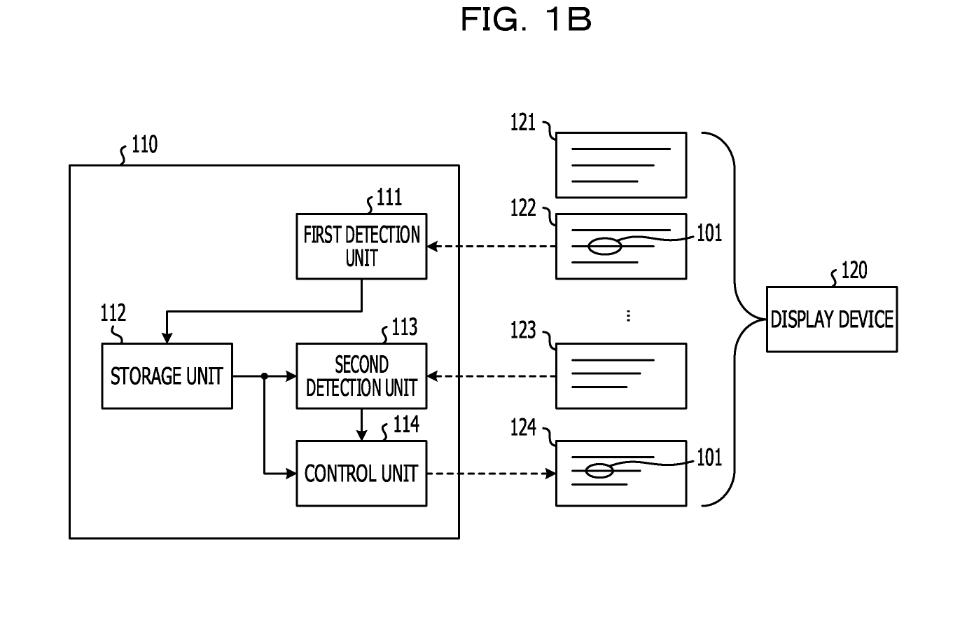

FIG. 1A is a diagram illustrating an example of a control device according to a first embodiment. FIG. 1B is a diagram illustrating an example of signal flows and control operation in the control device illustrated in FIG. 1A. A control device 110 illustrated in FIG. 1A and FIG. 1B is a control device that controls display of a display device 120. The display device 120 is a display device, such as a touch panel on which images are displayed, or the like. The display device 120 may be disposed in the same apparatus as that of the control device 110, or may be disposed in a different apparatus from the control device 110.

Display images 121 to 124 are individual display images that are displayed by the display device 120. In the example illustrated in FIG. 1A and FIG. 1B, it is assumed that when a display image on the display device 120 is the display image 121, a user has performed write operation on the display image 121. In the case where the display device 120 is a touch panel, write operation from the user is allowed to be touch operation on a display unit of the display device 120 by a finger, a pen, or the like, for example. The display image 122 is an image produced by overlaying write data 101 generated from the write operation by the user on the display image 121.

The control device 110 includes a first detection unit 111, a storage unit 112, a second detection unit 113, and a control unit 114. The first detection unit 111 detects write operation by the user on a first display image of the display image 121 displayed on the display device 120. The first detection unit 111 outputs a detection result to the storage unit 112.

When the first detection unit 111 detects the write operation, the storage unit 112 associates first feature information calculated from the display image 121 by a predetermined method with the write data 101 based on the write operation, and stores them.

After this, it is assumed that the display image by the display device 120 has changed, and becomes a display image 123 at a certain point in time. The display image 123 is an image having at least a part similar to that of the display image 121. Specifically, the display image 123 is an image having second feature information calculated by the above-described predetermined method becomes identical or similar to the first feature information of the display image 121 stored in the storage unit 112.

The second detection unit 113 detects display of the display image 123 by the display device 120. For example, the second detection unit 113 obtains image data indicating a display screen by the display device 120 at the time of changing a display screen by the display device 120, or periodically, and calculates feature information from the obtained image data so as to detect display of the display image 123 by the display device 120. The second detection unit 113 outputs a detection result to the control unit 114.

When the second detection unit 113 detects display of the display image 123, the control unit 114 displays the write data 101 stored in association with the first feature information of the display image 121 in the storage unit 112 together with the display image 123 on the display device 120. The display image 124 is a display image in which the display image 123 is displayed together with the write data 101.

In this manner, in the control device 110 according to the first embodiment, when writing by the user in the display image 121 is detected, a feature of the display image 121 and the write data 101 are stored. And when the display image 123 having a feature that is identical or similar to that of the display image 121 is displayed by the display device 120, the control device 110 displays the write data 101 in an overlaying manner on the display image 123. Thereby, it is possible to achieve a flexible writing function that is not dependent on an application, a context (state) of an application, and so on.

Also, by associating a feature of the display image 121 with the write data 101, and storing them, it is possible to reduce the storage capacity compared with a configuration of storing the display image 121 and the write data 101 in association with each other, for example. Also, it is possible to reduce the amount of detection processing by the second detection unit 113.

Storage of Relative Position

Also, in addition to the first feature information and the write data, the storage unit 112 may store a relative position of the write data 101 to the display image 121 in association. In this case, when the second detection unit 113 has detected display of the display image 123, the control unit 114 displays the write data 101 based on the relative position stored in association with the first feature information together with the display image 123 on the display device 120. Thereby, it is possible to reproduce the position of the write data 101 with high precision.

Detection by Divided Images

Also, individual divided images having at least a part overlapping the write data 101 out of a plurality of divided images obtained by dividing the display image 121 may be targeted, and first feature information calculated from the targeted divided images may be stored in association with the write data 101. In this case, the second detection unit 113 calculates second feature information from each of the plurality of divided images obtained by dividing the display image 123 by the display device 120. And the second detection unit 113 detects display, by the display device, of the display image 123 including the divided images whose second feature information identical or similar to the first feature information stored in the storage unit 112.

Thereby, if all of the display screen by the display device 120 do not match or resemble, it is possible to display the write data 101 in the case where an image of a part corresponding to the write data 101 is displayed again by the display device 120 out of the display image 121. Accordingly, even if the image is expanded or shrunk or scrolled, it is possible to reproduce the write data 101, and thus it is possible to achieve a flexible writing function.

Deletion of Old Write Data

Also, the storage unit 112 may delete the first feature information and the write data 101 that are stored in association with each other after an elapse of a predetermined time period from when the information and the data are stored. Thereby, it is possible to delete the old write data 101.

### Second Embodiment

### Information Processing Apparatus According to Second Embodiment

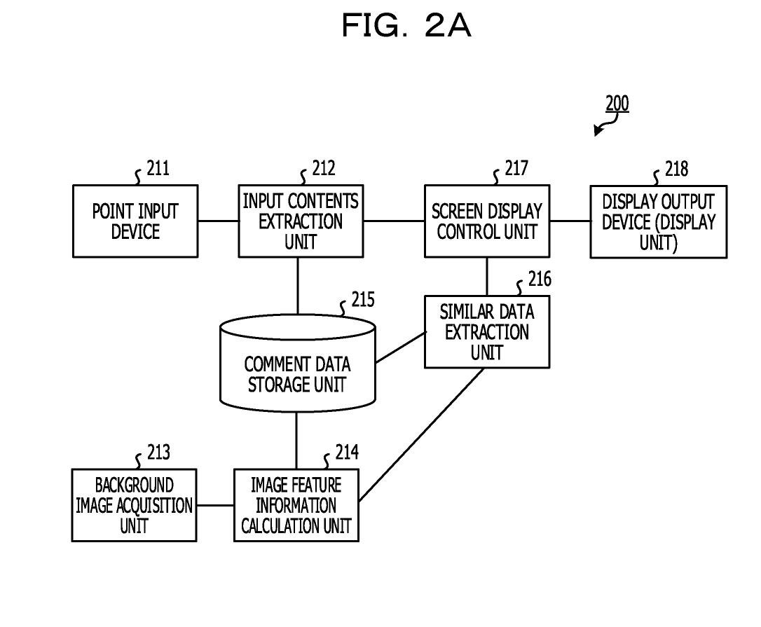

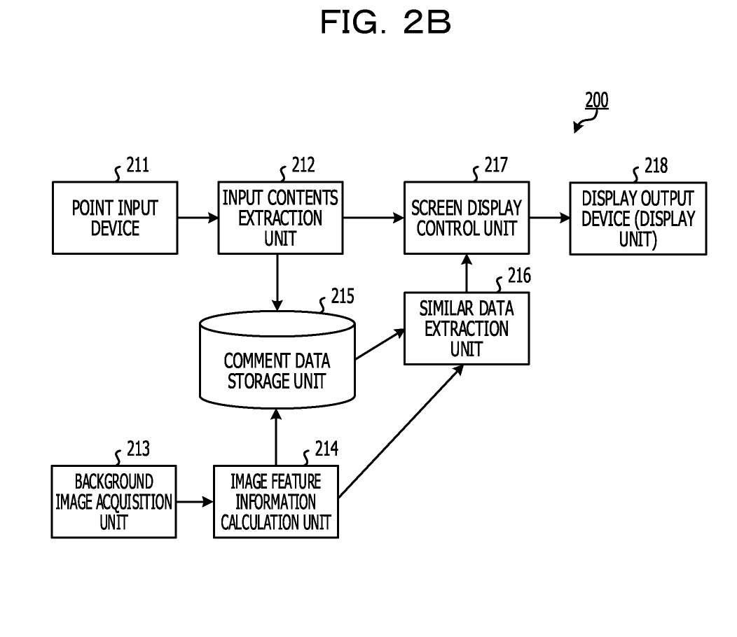

FIG. 2A is a diagram illustrating an example of an information processing apparatus according to a second embodiment. FIG. 2B is a diagram illustrating an example of signal flows in the information processing apparatus illustrated in FIG. 2A. As illustrated in FIG. 2A and FIG. 2B, an information processing apparatus 200 according to the second embodiment includes a point input device 211, an input contents extraction unit 212, and a background image acquisition unit 213. Also, the information processing apparatus 200 includes an image feature information calculation unit 214, a comment data storage unit 215, a similar data extraction unit 216, a screen display control unit 217, and a display output device 218.

The point input device 211 is an input device that designates an input position or coordinates on a display screen of the display output device 218. It is possible to achieve the point input device 211 by a mouse, a track pad, a track ball, and so on, for example. Also, the point input device 211 and the display output device 218 may be achieved by an input-output combination device, such as a touch panel, or the like. The point input device 211 outputs input information from a user to the input contents extraction unit 212.

The input contents extraction unit 212 extracts a comment input by the user based on the input information output from the point input device 211. The comment is write data, such as a figure, a character string, and so on, for example. In the case where the point input device 211 is a touch panel, for example, the input contents extraction unit 212 extracts a sequence of points of a locus of contact points on the point input device 211 in a predetermined time period after contact on the touch panel is detected as a series of comments. The predetermined period may be a period until at the time when non-contact on the touch panel continues for a predetermined time period, for example. The input contents extraction unit 212 outputs the extracted comment to the comment data storage unit 215, and the screen display control unit 217.

The background image acquisition unit 213 obtains a background image (screen shot) on a display screen by the display output device 218. In order for the background image acquisition unit 213 to obtain a background image, it is possible to use an application programming interface (API) of an operating system (OS), for example. Alternatively, in order for the background image acquisition unit 213 to obtain a background image, a buffer acquisition API of a driver of the display output device 218 may be used. For a format of a background image obtained by the background image acquisition unit 213, it is possible to use various formats, such as a bitmap format, or the like, for example. The background image acquisition unit 213 outputs the obtained background image to the image feature information calculation unit 214.

The image feature information calculation unit 214 calculates a feature vector of the background image output from the background image acquisition unit 213. In order to calculate a feature vector by the image feature information calculation unit 214, it is possible to use a feature point extraction algorithms for keypoint detection and feature description, such as SIFT (scale invariant feature transform), SURF (speeded up robust features), and so on, for example. Thereby, it is possible to obtain robust feature information with respect to image comparison including partial matching, image matching at the time of enlargement and shrinkage, and so on. The image feature information calculation unit 214 outputs the calculated feature vector to the comment data storage unit 215, and the similar data extraction unit 216.

The comment data storage unit 215 stores the comment output from the input contents extraction unit 212 using the feature vector output from the image feature information calculation unit 214 as a key. For example, the comment data storage unit 215 encodes the comment in a decodable format, and stores a character string obtained by the encoding.

The similar data extraction unit 216 compares the feature vector stored in the comment data storage unit 215 and the feature vector output from the image feature information calculation unit 214. At this time, the similar data extraction unit 216 may also confirm positional consistency (bag-of-keypoints) in order to compare feature vectors in a bundle. Thereby, it is possible to exclude accidental similarity of the feature vectors.

When the similar data extraction unit 216 detects a feature vector identical or similarity to the feature vector output from the image feature information calculation unit 214 from the comment data storage unit 215, the similar data extraction unit 216 extracts a comment stored in association with the detected feature vector. The similar data extraction unit 216 outputs the extracted comment to the screen display control unit 217.

The screen display control unit 217 is a control unit that controls display contents of the display output device 218. For example, the screen display control unit 217 displays a screen of an application that is running on the information processing apparatus 200 on the display output device 218.

Also, when the input contents extraction unit 212 outputs the comment, the screen display control unit 217 displays the comment from the input contents extraction unit 212 on the display output device 218 in an overlaying manner on the screen being displayed on the display output device 218. Thereby, the user is allowed to confirm the input result of the comment.

Also, when the similar data extraction unit 216 outputs the comment, the screen display control unit 217 displays the comment from the similar data extraction unit 216 on the display output device 218 in an overlaying manner on the screen being displayed on the display output device 218. Thereby, the user is allowed to display a comment input in the past.

The display output device 218 is a display unit that displays a screen under the control of the screen display control unit 217. For the display output device 218, for example, it is possible to use a liquid crystal display, a plasma display, and so on. Also, as described above, the point input device 211 and the display output device 218 may be achieved by an input-output combination device, such as a touch panel, or the like.

It is possible to achieve the control device 110 and the display device 120 illustrated in FIG. 1A and FIG. 1B, for example, by the information processing apparatus 200. It is possible to achieve the first detection unit 111 illustrated in FIG. 1A and FIG. 1B, for example, by the point input device 211 and the input contents extraction unit 212. It is possible to achieve the storage unit 112 illustrated in FIG. 1A and FIG. 1B, for example, by the image feature information calculation unit 214 and the comment data storage unit 215.

It is possible to achieve the second detection unit 113 illustrated in FIG. 1A and FIG. 1B, for example, by the background image acquisition unit 213, the image feature information calculation unit 214, and the similar data extraction unit 216. It is possible to achieve the control unit 114 illustrated in FIG. 1A and FIG. 1B, for example, by the screen display control unit 217. It is possible to achieve the display device 120 illustrated in FIG. 1A and FIG. 1B, for example, by the display output device 218.

Hardware Configuration of Information Processing Apparatus

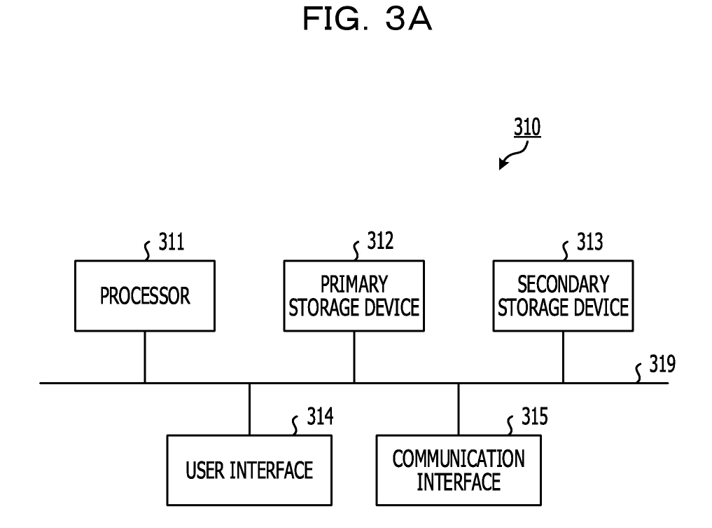

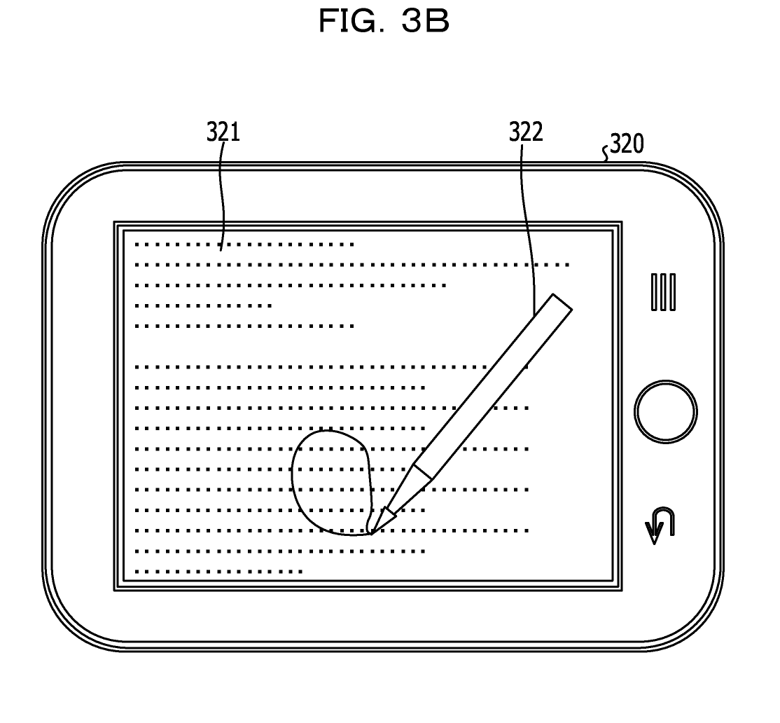

FIG. 3A is a diagram illustrating an example of a hardware configuration of the information processing apparatus. It is possible to achieve the information processing apparatus 200 illustrated in FIG. 2A and FIG. 2B, for example, by the information processing apparatus 310 illustrated in FIG. 3A. The information processing apparatus 310 includes a processor 311, a primary storage device 312, a secondary storage device 313, a user interface 314, and a communication interface 315. The processor 311, the primary storage device 312, the secondary storage device 313, the user interface 314, and the communication interface 315 are connected through a bus 319.

The processor 311 performs overall control on the information processing apparatus 310. The processor 311 includes, for example, a central processing unit (CPU) and a graphics processing unit (GPU).

The primary storage device 312 (main memory) is used as a work area of the processor 311. It is possible to achieve the primary storage device 312, for example, by a random access memory (RAM).

The secondary storage device 313 is, for example, a nonvolatile memory, such as a magnetic disk, an optical disc, a flash memory, or the like. The secondary storage device 313 stores various programs that operate the information processing apparatus 310. The programs stored in the secondary storage device 313 are loaded onto the primary storage device 312, and are executed by the processor 311.

The user interface 314 includes, for example, an input device that accepts operation input from the user, and an output device that outputs information to the user, and the like. It is possible to achieve the input device, for example, by keys (for example, a keyboard), a remote controller, and the like. It is possible to achieve the output device, for example, by a display unit, a speaker, and the like. Also, the input device and the output device may be achieved by a touch panel, or the like (for example, refer to FIG. 3B). The user interface 314 is controlled by the processor 311.

The communication interface 315 is a communication interface that performs communication with the outside of the information processing apparatus 310 in a wireless or a wired manner, for example. The communication interface 315 is controlled by the processor 311.

It is possible to achieve the point input device 211 and the display output device 218 illustrated in FIG. 2A and FIG. 2B, for example, by the user interface 314 illustrated in FIG. 3A. It is possible to achieve the input contents extraction unit 212, the background image acquisition unit 213, the image feature information calculation unit 214, the similar data extraction unit 216, and the screen display control unit 217 that are illustrated in FIG. 2A and FIG. 2B, for example, by the processor 311 illustrated in FIG. 3A. It is possible to achieve the comment data storage unit 215 illustrated in FIG. 2A and FIG. 2B, for example, by the processor 311 and the secondary storage device 313 that are illustrated in FIG. 3A.

FIG. 3B is a diagram illustrating an example of a tablet terminal to which the information processing apparatus is applied. A tablet terminal 320 illustrated in FIG. 3B is a tablet terminal to which the information processing apparatus 310 illustrated in FIG. 3A is applied. The processor 311, the primary storage device 312, the secondary storage device 313, and the communication interface 315 that are illustrated in FIG. 3A are included in the tablet terminal 320.

Also, the user interface 314 illustrated in FIG. 3A is achieved by a touch panel 321 of the tablet terminal 320. The touch panel 321 displays an image to the user. Also, the touch panel 321 accepts input of an instruction, such as a position on a display screen, and so on by touched by a pen 322, a user's finger, and the like. It is possible to use various kinds of touch panels, such as a pressure-sensitive touch panels, electrostatic touch panels, and so on, for the touch panel 321.

Storage of Comment Data

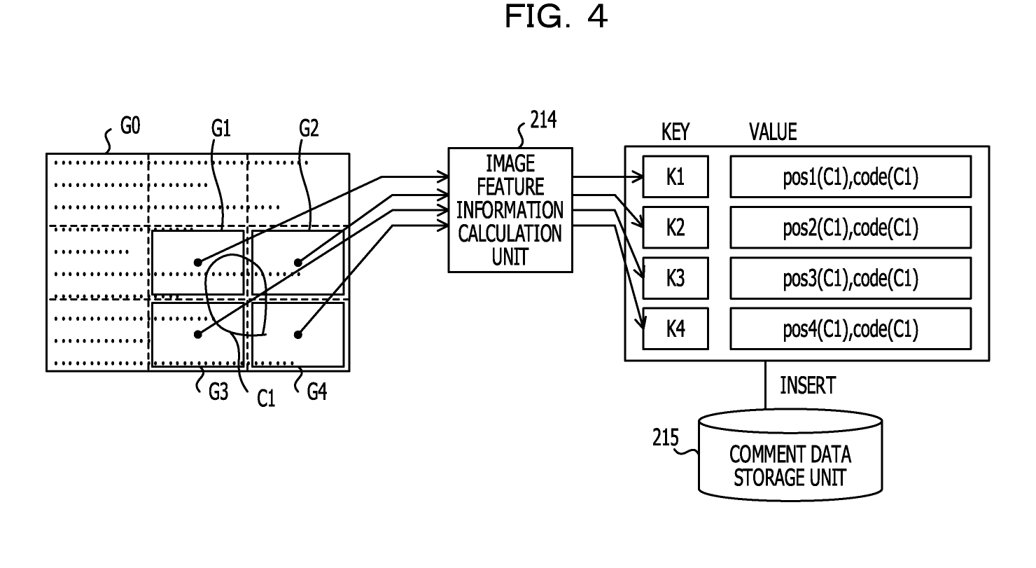

FIG. 4 is a diagram illustrating an example of comment data storage. A display image G0 illustrated in FIG. 4 is a display image (full screen) by the display output device 218. The comment C1 is a comment input by the user on the display image G0. The input contents extraction unit 212 extracts the comment C1. When input of the comment C1 is detected, the background image acquisition unit 213 obtains the display image G0.

Divided images G1 to G4 are divided images including at least a part of the comment C1 out of nine divided images (blocks) obtained by dividing the display image G0 into nine parts. The image feature information calculation unit 214 calculates the corresponding feature vectors K1 to K4 of the divided images G1 to G4. In this regard, here, a description will be given of the case of dividing a display image of the display output device 218 into nine parts. However, the number of divisions of a display image of the display output device 218 is not limited to nine.

The comment data storage unit 215 associates a feature vector K1 calculated by the image feature information calculation unit 214 with a relative position post (C1) and a character string code (C1) for the divided image G1, and stores (inserts) them. At this time, the feature vector K1 is stored as a key, and the relative position post (C1) and the character string code (C1) are stored as values into the comment data storage unit 215.

The relative position post (C1) is a relative position of the comment C1 on the divided image G1. For example, the relative position post (C1) is a relative position of the coordinates of a center position (or a gravity center position) of the comment C1 with respect to the coordinates of an upper-left corner of the divided image G1. The character string code (C1) is a character string code of the encoded comment C1.

Also, the comment data storage unit 215 associates each of the divided images G2 to G4 with a corresponding one of the feature vectors K2 to K4, the relative positions pos2 and pos4 (C1), and the character string codes (C1) in the same manner, and stores them into the comment data storage unit 215. In this manner, the comment data storage unit 215 associates each divided image GX with a corresponding feature vector KX, a corresponding relative position posX (C1), and a corresponding character string code (C1), and stores them.

Reading Comment Data

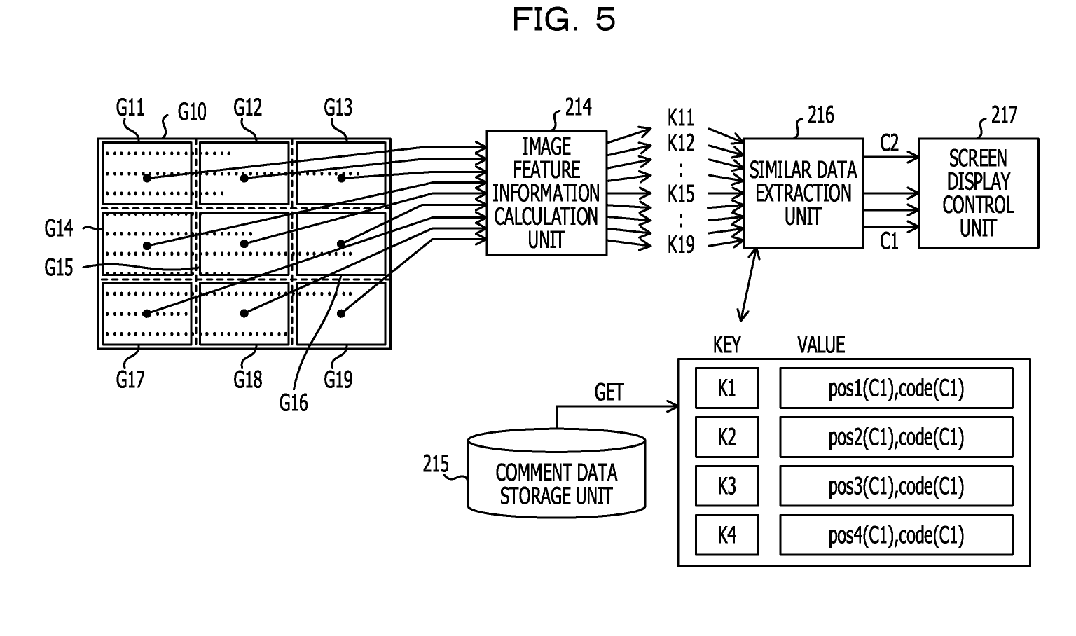

FIG. 5 is a diagram illustrating an example of reading comment data. A display image G10 illustrated in FIG. 5 is a display image (full screen) on the display output device 218. The background image acquisition unit 213 obtains the display image G10 in order to determine whether past comments are included or not on the screen being displayed after performing storage processing of the comment data, which is illustrated in FIG. 4. For example, the background image acquisition unit 213 obtains the display image G10 periodically or at the time of changing the display image by the display output device 218.

Divided images G11 to G19 are nine divided images (blocks) obtained by dividing the display image G10 into nine parts. The image feature information calculation unit 214 calculates corresponding feature vectors K11 to K19 of the divided images G11 to G19.

The similar data extraction unit 216 performs comparison processing on each of the feature vectors K11 to K19 calculated by the image feature information calculation unit 214 with the feature vectors K1 to K4 that are stored in the comment data storage unit 215 (GET). In the example illustrated in FIG. 5, it is assumed that the feature vector K15 of the divided image G15 is similar to the feature vector K1 of the comment data storage unit 215. In this case, the similar data extraction unit 216 obtains the relative position post (C1) and the character string code (C1) that are associated with the feature vector K1 in the comment data storage unit 215.

The similar data extraction unit 216 notifies the divided image G15 corresponding to the feature vector K15, the obtained relative position post (C1), and the character string code (C1) to the screen display control unit 217. The screen display control unit 217 controls the display output device 218 such that the character string code (C1) is displayed in an overlaying manner at a position where the relative position to the divided image G15 becomes the relative position post (C1) based on the notification of the similar data extraction unit 216.

Storage Processing of Comment Data

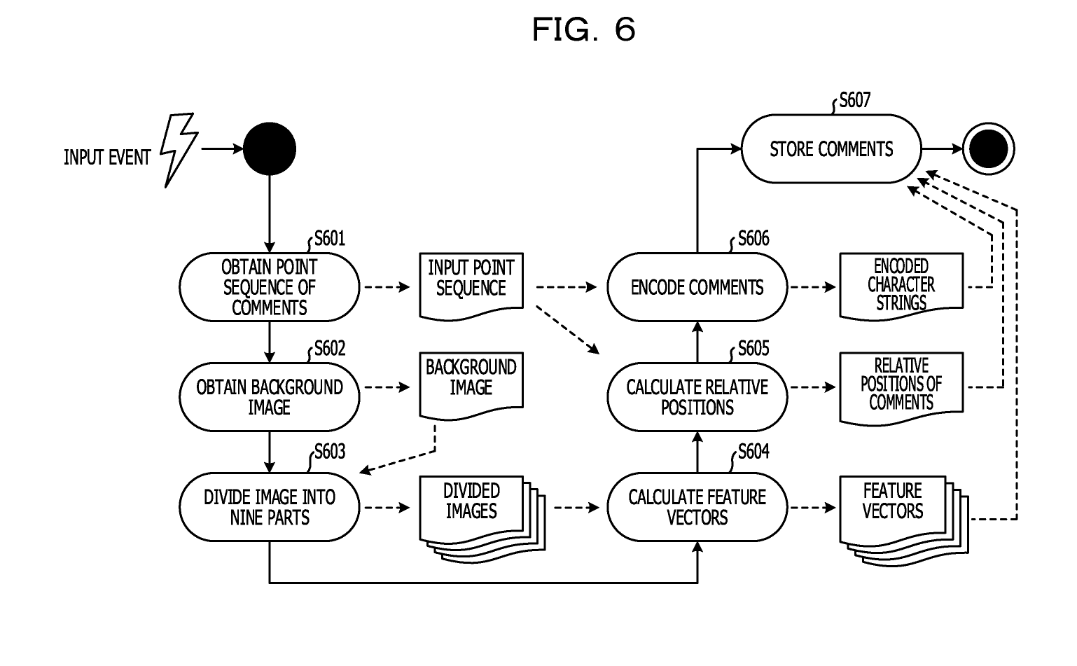

FIG. 6 is a flowchart illustrating an example of storage processing of comment data. When an input event of a comment on the display image of the display output device 218 occurs, the information processing apparatus 200 executes, for example, each step illustrated in FIG. 6 as comment data storage processing. Each step illustrated in FIG. 6 is executed by the processor 311, for example.

First, the input contents extraction unit 212 obtains a point sequence (an input point sequence) of the input comment (step S601). Next, the background image acquisition unit 213 obtains a background image currently being displayed on the display output device 218 (step S602). Next, the image feature information calculation unit 214 divides the background image obtained in step S602 into nine parts (step S603).

Next, the image feature information calculation unit 214 calculates a feature vector of each divided image obtained in step S603 (step S604). Next, the comment data storage unit 215 calculates a relative position of the input comment in each of the divided images obtained in step S603 based on the input point sequence obtained in step S601 (step S605). Next, the comment data storage unit 215 encodes the input comment based on the input point sequence obtained in step S601 (step S606).

Next, the comment data storage unit 215 stores the comment (step S607). That is to say, the comment data storage unit 215 associates the feature vector of each divided image calculated in step S604 with the relative position of the comment in each divided image calculated in step S605, and the encoded character string obtained in step S606, and stores them. And the information processing apparatus 200 terminates a series of comment data storage processing.

Read Processing of Comment Data

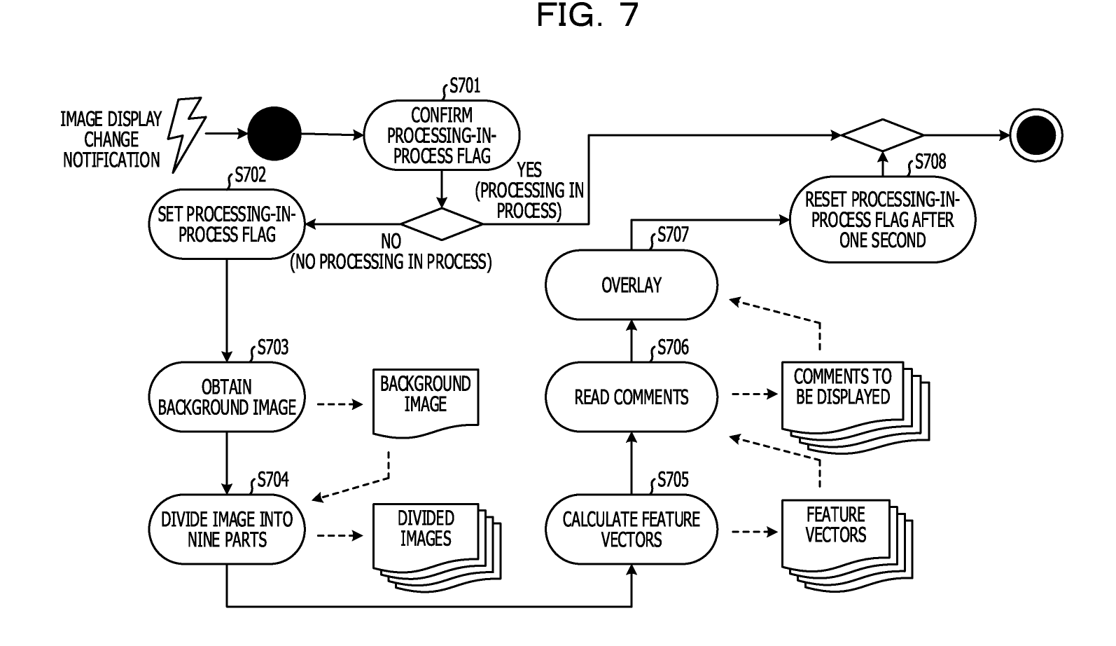

FIG. 7 is a flowchart illustrating an example of read processing of comment data. When the screen display control unit 217 detects a change in the screen display contents (screen display change notification), the information processing apparatus 200 executes each step illustrated in FIG. 7 as read processing of the comment data, for example. Each step illustrated in FIG. 7 is executed under the control of the processor 311, for example.

First, the processor 311 of the information processing apparatus 200 checks an processing-in-process flag to determine whether the processing is in process or not (step S701). The processing-in-process flag is information, for example, stored in the primary storage device 312 and indicating whether the read processing of comment data is being executed or not. If the processing is in process (step S701: Yes), the information processing apparatus 200 terminates the read processing of a series of comment data. Thereby, it is possible to avoid execution of the following each step in duplication.

In step S701, if the processing is not in process (no processing in process) (step S701: No), the processor 311 of the information processing apparatus 200 sets the processing-in-process flag (step S702). Next, the background image acquisition unit 213 obtains the background image that is currently being displayed by the display output device 218 (step S703). Next, the image feature information calculation unit 214 divides the background image obtained in step S703 into nine parts (step S704).

Next, the image feature information calculation unit 214 calculates a feature vector of each divided image obtained in step S704 (step S705). Next, the similar data extraction unit 216 reads comments corresponding to the feature vector that is identical or similar to the feature vector calculated in step S705 from the comment data storage unit 215 (step S706).

Next, the screen display control unit 217 controls the display output device 218 such that a display-target comment read in step S706 is displayed in an overlaying manner on the background image that is currently being displayed on the display output device 218 (step S707). Next, the processor of the information processing apparatus 200 resets the processing-in-process flag after an elapse of one second from step S707 (step S708), and terminates the read processing of the series of comment data.

Calculation of Feature Vector

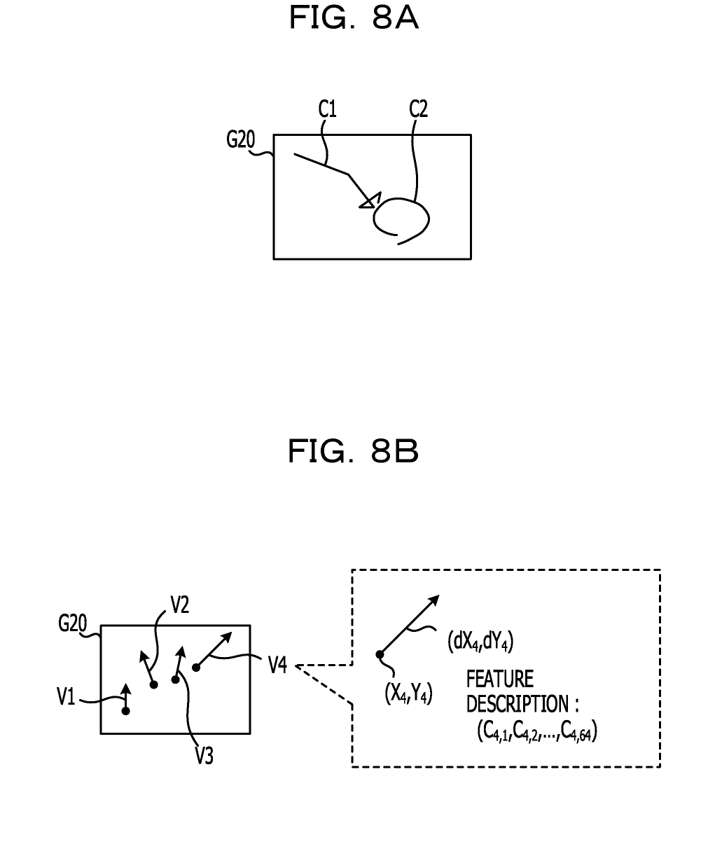

FIG. 8A is a diagram illustrating an example of comments input by a user. A divided image G20 illustrated in FIG. 8A is one of the divided images obtained by dividing a display image (full screen) by the display output device 218. The comments C1 and C2 are comments included in the divided image G20 out of the comments input by the user.

FIG. 8B is a diagram illustrating an example of feature vectors. The image feature information calculation unit 214 calculates feature vectors of the divided image G20 illustrated in FIG. 8A, for example. The feature vectors V1 to V4 illustrated in FIG. 8B are feature vectors calculated from the divided image G20 by the image feature information calculation unit 214.

It is possible to indicate the feature vectors V1 to V4 by the corresponding positions, directions, feature descriptions. For example, it is possible to indicate the position of the feature vector V4 by a two-dimensional position (X₄, Y₄). Also, it is possible to indicate the direction of the feature vector V4 by a two-dimensional (dX₄, dY₄).

Also, it is possible to indicate the feature description of the feature vector V4 by a 64-dimentional (C_{4, 1}, C_{4, 2}, . . . , C_{4, 64}). Alternatively, it is possible to indicate the feature description of the feature vector V4 by a 128-dimentional (C_{4, 1}, C_{4, 2}, . . . , C_{4, 128}). The feature description is a descriptor obtained by a hash function having a feature mapping near vectors to close values, for example.

The comment data storage unit 215 calculates a relative position pos (C1) and a relative position pos (C2) of the comments C1 and C2, respectively in the divided image G20. Also, the comment data storage unit 215 converts the comments C1 and C2 into the character string code (C1) and the character string code (C2) by a specific decodable encoding method.

Data Stored in Comment Data Storage Unit

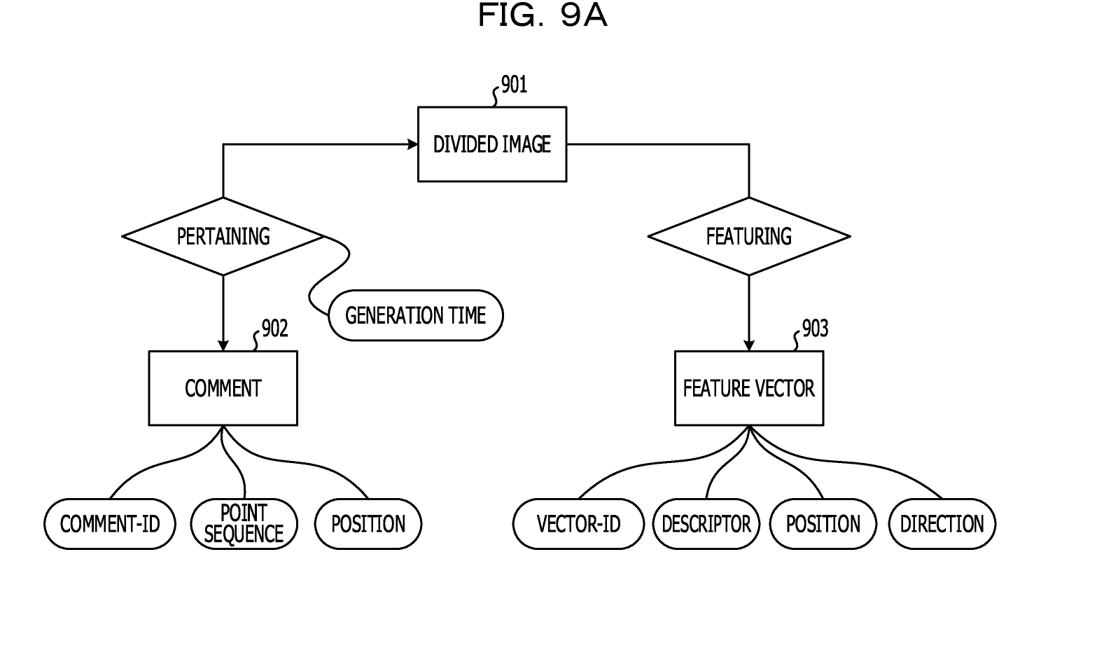

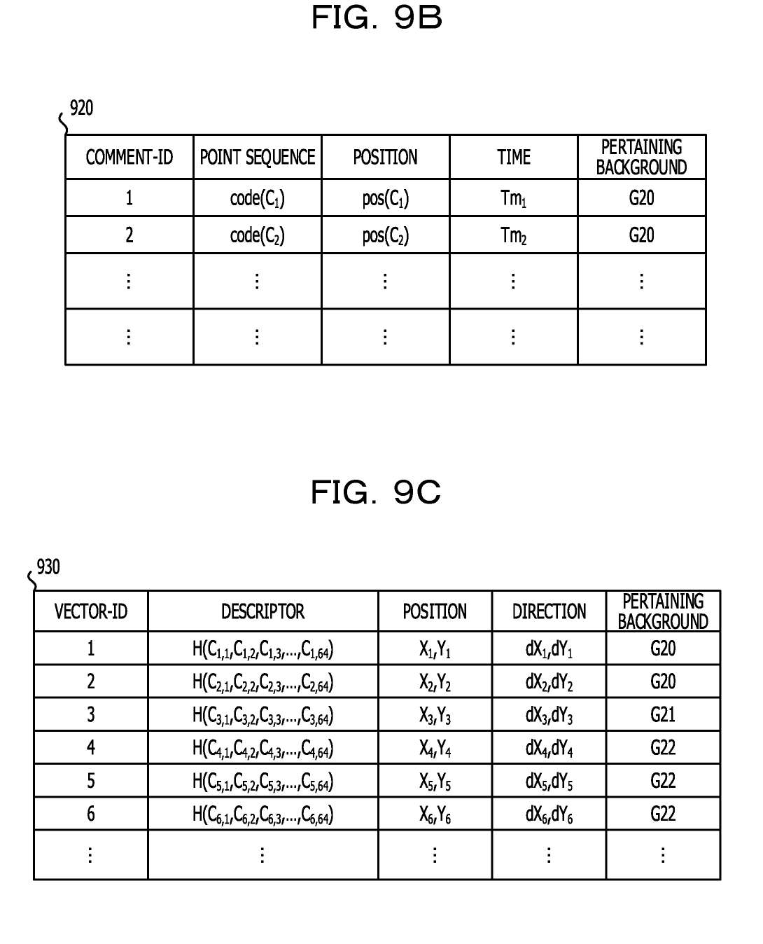

FIG. 9A is a diagram illustrating an example of an ER diagram on data stored in the comment data storage unit. As illustrated in FIG. 9A, the comment data storage unit 215 stores a comment 902 for each divided image 901, and a plurality of feature vectors 903 for each divided image 901. Also, the attributes of the comment 902 include a comment-ID, a point sequence, a position, generation time, and a belonging background. Also, the attributes of the feature vector 903 include a vector-ID, a descriptor, a position, a direction, and a belonging background.

FIG. 9B is a diagram illustrating an example of a comment table stored in the comment data storage unit. FIG. 9C is a diagram illustrating an example of a feature vector table stored in the comment data storage unit. The comment data storage unit 215 stores a comment table 920 illustrated in FIG. 9B and a feature vector table 930 illustrated in FIG. 9C, for example.

The comment table 920 stores a comment ID, a point sequence, a position, generation time (a point in time), and a belonging background for each comment corresponding to a divided image. The feature vector table 930 stores a vector-ID, a descriptor, a position, a direction, and a belonging background for each feature vector of a feature point included in the divided image.

The comment data storage unit 215 may be configured to delete comment data having a predetermined time period that have elapsed from generation time out of the individual comment data in the comment table 920. Thereby, it is possible to delete old comment data.

Database Collation of Past Comments

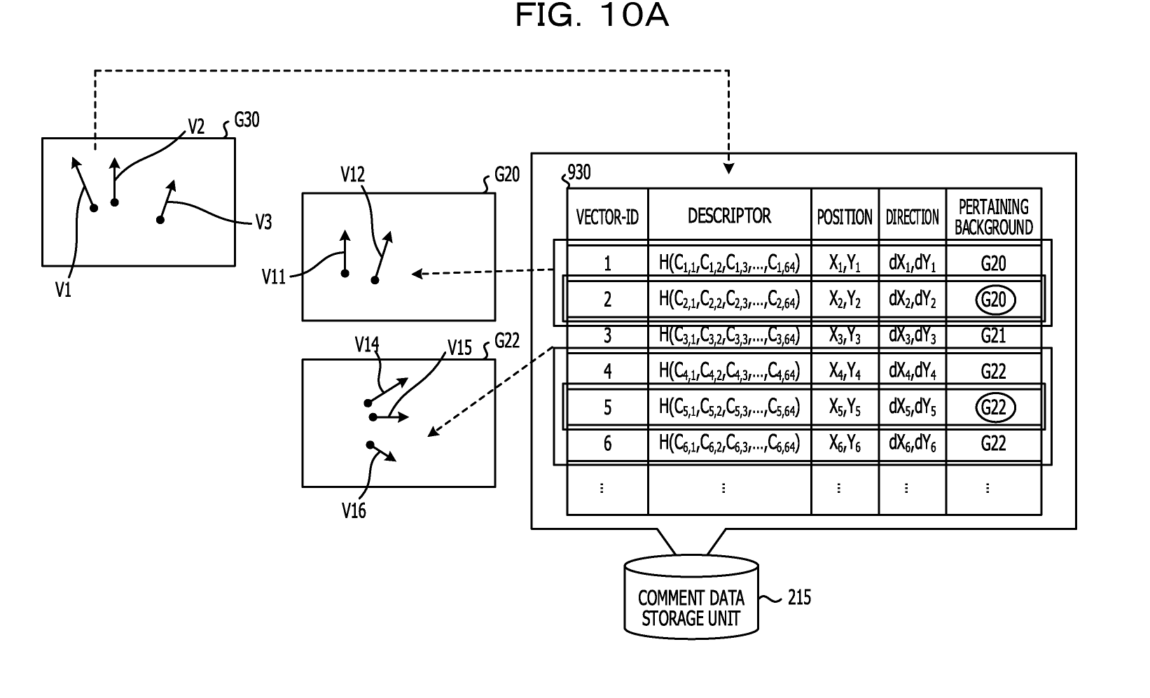

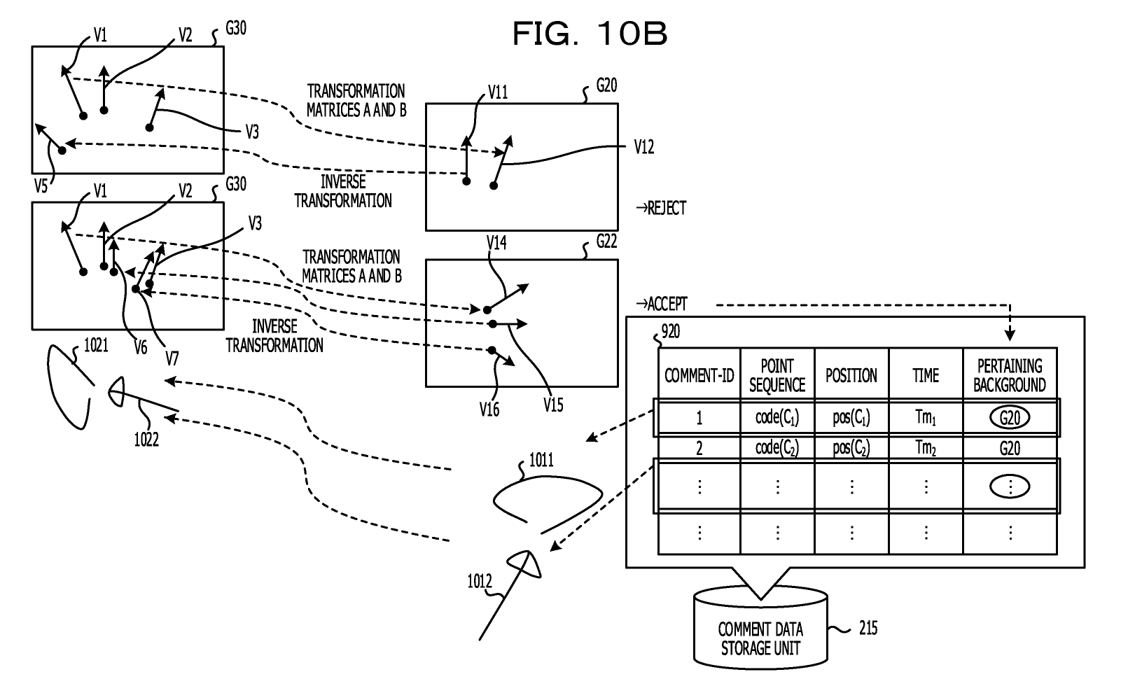

FIG. 10A is a diagram (1 of 2) illustrating an example of database collation of past comments. FIG. 10B is a diagram (2 of 2) illustrating an example of database collation of past comments. In FIG. 10A and FIG. 10B, a same symbol is given to a same part as that illustrated in FIG. 9A and FIG. 9B, and the description thereof is omitted.

A divided image G30 illustrated in FIG. 10A is one of divided images obtained by dividing a display image (full screen) on the display output device 218. The similar data extraction unit 216 first extracts feature vectors V1 to V3 of the divided image G30. And the similar data extraction unit 216 extracts a feature vector identical or similar to each of the extracted feature vectors V1 to V3 from the feature vector table 930. In the example illustrated in FIG. 10A, it is assumed that as feature vectors similar to the feature vector V1, a feature vector V12 having a vector-ID of “2”, and a feature vector V14 having a vector-ID of “5” are extracted.

The similar data extraction unit 216 first obtains the divided image G20 as a background image associated with the extracted feature vector V11 from the feature vector table 930. And the similar data extraction unit 216 extracts the feature vectors V11 and V12 having the vector-IDs of “1” and “2”, respectively, that correspond to the obtained divided image G20 from the feature vector table 930.

Also, the similar data extraction unit 216 first obtains the divided image G22 as a background image associated with the extracted feature vector V14 from the feature vector table 930. And the similar data extraction unit 216 extracts feature vectors V14 to V16 having vector-IDs of “4”, “5”, and “6”, respectively, that correspond to the obtained divided image G22 from the feature vector table 930.

Next, as illustrated in FIG. 10B, the similar data extraction unit 216 calculates a transformation matrix A from the position of the feature vector V1 to the position of the feature vector V12. Also, the similar data extraction unit 216 calculates a transformation matrix B from the direction of the feature vector V1 to the direction of the feature vector V12. And the similar data extraction unit 216 calculates a feature vector V5 by multiplying the position of the feature vector V11 associated with the divided image G20 in the same manner as the feature vector V12 by the transformation vector A, and multiplying the direction of the feature vector V11 by the transformation vector B (inverse transformation).

Next, the similar data extraction unit 216 compares the calculated feature vector V5 with the feature vectors V2 and V3 of the divided image G30 so as to compare the divided image G30 and the divided image G20. In the example illustrated in FIG. 10B, the feature vector V5 is similar neither to the feature vectors V2 and V3. In this case, the similar data extraction unit 216 determines that the divided image G20 is not similar to the divided image G30 (Reject).

Also, the similar data extraction unit 216 calculates the transformation matrix A from the position of the feature vector V1 to the position of the feature vector V14. Also, the similar data extraction unit 216 calculates the transformation matrix B from the direction of the feature vector V1 to the direction of the feature vector V14. And the similar data extraction unit 216 calculates feature vectors V6 and V7 by multiplying the positions of the feature vectors V15 and V16 associated with the divided image G22 in the same manner as the feature vector V14 by the transformation vector A, and multiplying the directions of the feature vectors V15 and V16 by the transformation vector B (inverse transformation).

Next, the similar data extraction unit 216 compares the calculated feature vectors V6 and V7 with the feature vectors V2 and V3 so as to compare the divided image G30 with the divided image G22. In the example illustrated in FIG. 10B, it is assumed that the feature vectors V6 and V7 are similar to the feature vectors V2 and V3, respectively. In this case, the similar data extraction unit 216 determines that the divided image G22 is similar to the divided image G30 (Accept).

In this case, the similar data extraction unit 216 obtains a comment associated with the divided image G22 in the comment table 920 of the comment data storage unit 215. In the example illustrated in FIG. 10B, the similar data extraction unit 216 obtains comment data (a point sequence and a position) having a comment ID of “1”, and so on. Comments 1011 and 1012 illustrated in FIG. 10B are comments indicated by the comment data obtained by the similar data extraction unit 216.

The screen display control unit 217 causes the display output device 218 to display comments 1021 and 1022 that have been subjected to coordinate transformation by multiplying the comments 1011 and 1012 by the transformation matrices A and B from the feature vector V1 to the feature vector V14, respectively.

It is possible to express the transformation matrix A (position) by R in the following expression (1), for example. Also, it is possible to express the transformation matrix B (direction) by the following expression (2), for example.

$$\begin{matrix}Expression 1 & \\ R = ( \begin{matrix}- 0.3109369 & - 0.9504056 \\ - 0.95043056 & 0.3109369\end{matrix} ) & ( 1 ) \\ t = ( \begin{matrix}1109.36640554 \\ 779.37010781\end{matrix} ) & ( 2 )\end{matrix}$$

If it is assumed that the relative position of the comment pos (C1)=P_{from}, it is possible to calculate a position Pₜₒ at which a comment is to be displayed out of the display image of the display output device 218 by R⁻¹P_{from}−t, using the expression (1) and the expression (2).

Display Image at Comment Input Time

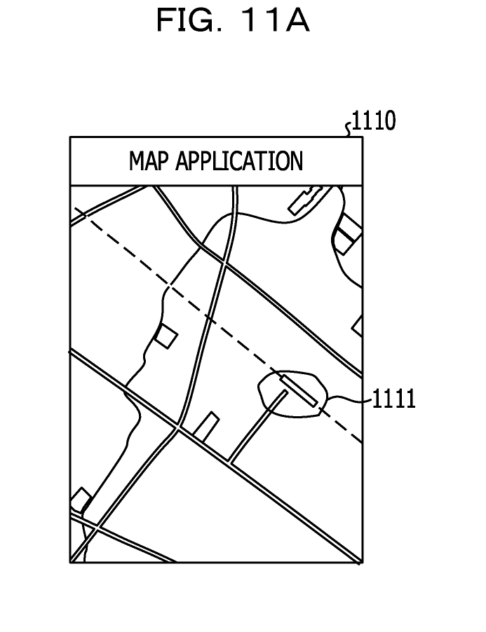

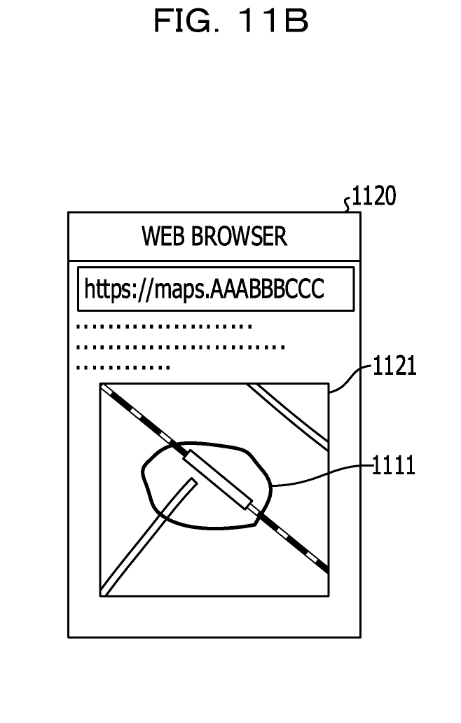

FIG. 11A is a diagram illustrating an example of a display image at comment input time. A display image 1110 illustrated in FIG. 11A is a display image by the display output device 218 when a map application is running on the information processing apparatus 200. In the example illustrated in FIG. 11A, it is assumed that a user has written a comment 1111 in the display image 1110.

FIG. 11B is a diagram illustrating an example of a comment display of another display image. A display image 1120 illustrated in FIG. 11B is a display image on the display output device 218 when a Web browser is running on the information processing apparatus 200. The display image 1120 includes an image 1121 that is similar to a part in which the comment 1111 is written out of the display image 1110 illustrated in FIG. 11A. In this case, the information processing apparatus 200 displays the comment 1111 in an overlaying manner on the image 1121.

In this manner, by the information processing apparatus 200 according to the second embodiment, it is possible to achieve a writing function (commenting function) independently of an application and an application context (state). Accordingly, it becomes possible to reproduce writing contents on a certain application in another application that displays an identical or similar image.

Also, it is not desired to implement an independent writing function in each application, and thus it is possible to simplify the application. Also, it is possible to perform writing in a unified operation independently of an application and an application context (state), and thus it becomes easy to perform writing operation.

As described above, by the control device, the control method, and the control program, it is possible to achieve a flexible writing function.

In this regard, it is possible to achieve the method of processing information described in this embodiment, for example, by executing a program provided in advance on a computer, such as a personal computer, a workstation, and so on. This program is recorded on a computer-readable recording medium, such as a hard disk, a flexible disk, a CD-ROM, an MO, a DVD, and so on, and is executed by being read by the computer from the recording medium. Also, the program may be distributed through a network, such as the Internet, and the like.

Also, the program may be a resident program that is operated in a resident state while the information processing apparatus 310 is running. Thereby, it is possible to achieve writing function regardless of the other applications that are running on the information processing apparatus 310.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A control device comprising:
a memory; and
a processor coupled to the memory, configured to
perform first detection in order to detect write operation by a user on a first display image displayed on a display device,
when the write operation is detected by the first detection, associate first feature information calculated from the first display image with write data by the write operation, and store the first feature information and the write data into the memory,
perform second detection in order to detect display of a second display image whose second feature information corresponding to the stored first feature information is calculated on the display device, and
when the display of the second display image is detected by the second detection, display the write data stored in association with the first feature information together with the second display image on the display device.

2. The control device according to claim 1, wherein the processor is configured to
associate and store the first feature information, the write data, and a relative position of the write data with respect to the first display image, and
display the write data together with the second display image on the display device based on the relative position stored in association with the first feature information.

3. The control device according to claim 1, wherein the processor is configured to
target individual divided images having at least a part overlapping the write data out of a plurality of divided images obtained by dividing the first display image,
associate and store first feature information calculated from the targeted divided images with the write data, and
in the second detection, calculate second feature information from a plurality of the individual divided images obtained by dividing second display image on the display device so as to detect display of the second display image on the display device including the divided images having the second feature information identical or similar to the first feature information stored in the memory.

4. The control device according to claim 3, wherein the processor is configured to
associate and store first feature information calculated from the target divided images, the write data, and a relative position of the write data to the target divided images, and
display the write data on the display device based on the relative position stored in association with the first feature information together with the second display image.

5. The control device according to claim 1, wherein the processor is configured to
obtain image data indicating a display screen displayed on the display device when a display screen on the display device is changed or periodically in the second detection, and
calculate feature information from the obtained image data so as to detect display of the second display image on the display device.

6. The control device according to claim 1, wherein the processor is configured to delete the first feature information and the write data stored in association after a predetermined time period has passed since the storage.

7. The control device according to claim 1, wherein the first display image is a display image of a first application, and
the second display image is a display image of a second application different from the first application.

8. The control device according to claim 1, wherein the processor is configured to perform second detection in order to detect display of a second display image whose second feature information being identical to the stored first feature information or being similarity to the stored first feature information is above a given level is calculated on the display device.

9. A control method, comprising:
detecting write operation by a user on a first display image displayed on a display device,
when the write operation is detected, associating and storing first feature information calculated from the first display image with write data by the write operation,
detecting display of a second display image whose second feature information correspond to the stored first feature information, and
when the display of the second display image is detected, displaying, by a processor, the write data stored in association with the first feature information together with the second display image on the display device.

10. A machine readable medium storing a program that, when executed by a processor, causes the processor to perform operations comprising:
detecting write operation by a user on first display image displayed on a display device,
when the write operation is detected, associating and storing first feature information calculated from the first display image with write data by the write operation,
detecting display of a second display image whose second feature information correspond to the stored first feature information, and
when the display of the second display image is detected, displaying the write data stored in association with the first feature information together with the second display image on the display device.
